(19) United States
(12) Patent Application Publication
(10) Pub. No.: US 2026/0133146 A1
(43) Pub. Date: May 14, 2026

(54) X-RAY INSPECTION METHOD AND X-RAY INSPECTION APPARATUS

(71) Applicant: SHIMADZU CORPORATION, Kyoto-shi (JP)

(72) Inventors: Naoki MORIMOTO, Kyoto-shi (JP); Kenji TAKUBO, Kyoto-shi (JP); Zhimin Xie, Kyoto-shi (JP); Zezheng Chen, Kyoto-shi (JP)

(21) Appl. No.: 19/389,575

(22) Filed: Nov. 14, 2025

(30) Foreign Application Priority Data
Nov. 14, 2024 (JP) 2024-198868
Aug. 26, 2025 (JP) 2025-140162

(51) Int. Cl. G01N 23/18; G01N 23/083

(52) U.S. Cl. CPC G01N 23/18; G01N 23/083; G01N 2223/305; G01N 2223/646

(57) ABSTRACT

An X-ray inspection method comprises: an X-ray transmission image acquisition step of performing X-ray imaging of an object 1 to acquire a two-dimensional X-ray transmission image 3a; a model generation step of generating a model corresponding to the object 1 including a defect 2 as a three-dimensional virtual model 4, using a known structural parameter for the object 1; a virtual transmission image generation step of generating a two-dimensional virtual transmission image 6a from the three-dimensional virtual model; and a parameter modification step of modifying a structural parameter of the three-dimensional virtual model 4 so as to make the two-dimensional virtual transmission image 6a closer to the two-dimensional X-ray transmission image 3a, using a comparison result between the two-dimensional X-ray transmission image 3a and the two-dimensional virtual transmission image 6a.

### TECHNICAL FIELD

The present invention relates to an X-ray inspection method and an X-ray inspection apparatus, and more particularly, to an X-ray inspection method and an X-ray inspection apparatus for performing X-ray imaging of an object.

### BACKGROUND ART

Conventionally, a defect inspection method (X-ray inspection method) and a defect inspection apparatus (X-ray inspection apparatus) for performing X-ray imaging of a specimen (object) are known (see, for example, Patent Literature 1).

Patent Literature 1 discloses a method for detecting an internal defect of a specimen by using spatially discrete data such as X-ray CT data obtained by performing tomographic imaging of the specimen. Patent Literature 1 discloses displaying a result of detecting a defect in the X-ray CT data of the specimen as a three-dimensional rendering image. Furthermore, Patent Literature 1 discloses detecting a defect in the three-dimensional rendering image and displaying it in different colors or in an enlarged view according to feature quantities such as the size, shape, or existing position of the defect. That is, in Patent Literature 1, the entirety of the specimen and the defect is generated as a three-dimensional rendering image.

### PRIOR ART REFERENCE

### PATENT LITERATURE

[Patent Literature 1] Japanese Patent No. 4523489

### SUMMARY OF THE INVENTION

### PROBLEM TO BE SOLVED BY THE INVENTION

As described above, in Patent Literature 1, the entirety of the specimen and the defect is generated as a three-dimensional rendering image. Although not described in Patent Literature 1, displaying the specimen as a three-dimensional rendering image (3D model) requires collecting a large amount of X-ray transmission images of the object, and also requires a very long time for the volume calculation to construct the 3D model. For this reason, acquiring three-dimensional data of a defect in an object requires a very long time, and in cases where defect detection is required in a short time, such as in-line inspections, there is an inconvenience that the defect detection method that constructs a 3D model as disclosed in Patent Literature 1 cannot be used. Therefore, an X-ray inspection method and an X-ray inspection apparatus capable of acquiring three-dimensional data of a defect in an object in a short time are desired.

The present invention has been made to solve the above-described problems, and one object of the present invention is to provide an X-ray inspection method and an X-ray inspection apparatus capable of acquiring three-dimensional data of a defect in an object in a short time.

### MEANS FOR SOLVING THE PROBLEM

To achieve the above object, an X-ray inspection method according to a first aspect of the present invention comprises: an X-ray transmission image acquisition step of performing X-ray imaging of an object to acquire a two-dimensional X-ray transmission image; a model generation step of generating a model corresponding to the object including a defect as a three-dimensional virtual model, using a known structural parameter for the object; a virtual transmission image generation step of generating a two-dimensional virtual transmission image from the three-dimensional virtual model; and a parameter modification step of modifying a structural parameter of the three-dimensional virtual model so as to make the two-dimensional virtual transmission image closer to the two-dimensional X-ray transmission image, using a comparison result between the two-dimensional X-ray transmission image and the two-dimensional virtual transmission image.

To achieve the above object, an X-ray inspection apparatus according to a second aspect of the present invention comprises: an imaging unit for performing X-ray imaging of an object; and a control unit for controlling the imaging unit, wherein the control unit is configured to perform: control to acquire a two-dimensional X-ray transmission image of the object; control to generate a model corresponding to the object including a defect as a three-dimensional virtual model, using a known structural parameter for the object; control to generate a two-dimensional virtual transmission image from the three-dimensional virtual model; and control to modify a structural parameter of the three-dimensional virtual model so as to make the two-dimensional virtual transmission image closer to the two-dimensional X-ray transmission image, using a comparison result between the two-dimensional X-ray transmission image and the two-dimensional virtual transmission image.

### EFFECTS OF THE INVENTION

The configuration of generating a model corresponding to the object including a defect as a three-dimensional virtual model using the known structural parameter for the object eliminates the need to generate a three-dimensional model from an X-ray transmission image. This eliminates the need to collect a large amount of X-ray transmission images of the object for generating the three-dimensional virtual model, and can suppress the time for volume calculation for generating the three-dimensional model. As a result, three-dimensional data of a defect in the object can be acquired in a short time.

### BRIEF DESCRIPTION OF THE DRAWINGS

FIG. 1 is a block diagram showing the overall configuration of an X-ray inspection apparatus according to a first embodiment of the present invention.

FIG. 2 is a diagram showing an object to be subjected to defect inspection according to the first embodiment of the present invention.

FIG. 3 is a diagram showing an X-ray transmission image of the object according to the first embodiment of the present invention.

FIG. 4 is a diagram showing a virtual model and a modified virtual model according to the first embodiment of the present invention.

FIG. 5 is a diagram showing a defect-free virtual model according to the first embodiment of the present invention.

FIG. 6 is a diagram showing a virtual transmission image generated from the virtual model and a modified virtual transmission image generated from the modified virtual model according to the first embodiment of the present invention.

FIG. 7 is a flowchart showing a defect inspection performed by a control unit according to the first embodiment of the present invention.

FIG. 8 is a sub-flowchart for acquiring a known structural parameter according to the first embodiment of the present invention.

FIG. 9 is a diagram showing a defect-free virtual transmission image generated from the defect-free virtual model according to the first embodiment of the present invention.

FIG. 10 is a block diagram showing the overall configuration of an X-ray inspection apparatus according to a second embodiment of the present invention.

FIG. 11 is a diagram for explaining a linear attenuation coefficient distribution and first training projection data according to the second embodiment of the present invention.

FIG. 12 is a diagram for explaining the content that a trained model learns according to the second embodiment of the present invention.

FIG. 13 is a flowchart showing a defect inspection performed by a control unit according to the second embodiment of the present invention.

FIG. 14 is a sub-flowchart for detecting a defect portion according to the second embodiment of the present invention.

FIG. 15 is a diagram for explaining defect projection data output using the trained model according to the second embodiment of the present invention.

FIG. 16 is a diagram for explaining defect tomographic data generation according to the second embodiment of the present invention.

FIG. 17 is a block diagram showing the overall configuration of an X-ray inspection apparatus according to a third embodiment of the present invention.

FIG. 18 is a diagram for explaining a method of generating first training defect projection data, training defect tomographic data, and second training defect projection data according to the third embodiment of the present invention.

FIG. 19 is a diagram for explaining a method of generating third training defect projection data according to the third embodiment of the present invention.

FIG. 20 is a diagram for explaining the content that a trained model learns according to the second embodiment of the present invention.

FIG. 21 is a flowchart showing a defect inspection performed by a control unit according to the third embodiment of the present invention.

FIG. 22 is a sub-flowchart for detecting a defect portion according to the third embodiment of the present invention.

FIG. 23 is a diagram for explaining defect projection data output using a trained model.

FIG. 24 is a diagram for explaining a method of generating first detection defect projection data, first defect tomographic data, and second detection defect projection data according to the third embodiment of the present invention.

FIG. 25 is a diagram for explaining a method of generating third detection defect projection data according to the third embodiment of the present invention.

FIG. 26 is a diagram for explaining defect tomographic data generation according to the third embodiment of the present invention.

### DESCRIPTION OF EMBODIMENTS

### First Embodiment

Hereinafter, a first embodiment embodying the present invention will be described with reference to the drawings.

### Overall Configuration of X-ray Inspection Apparatus

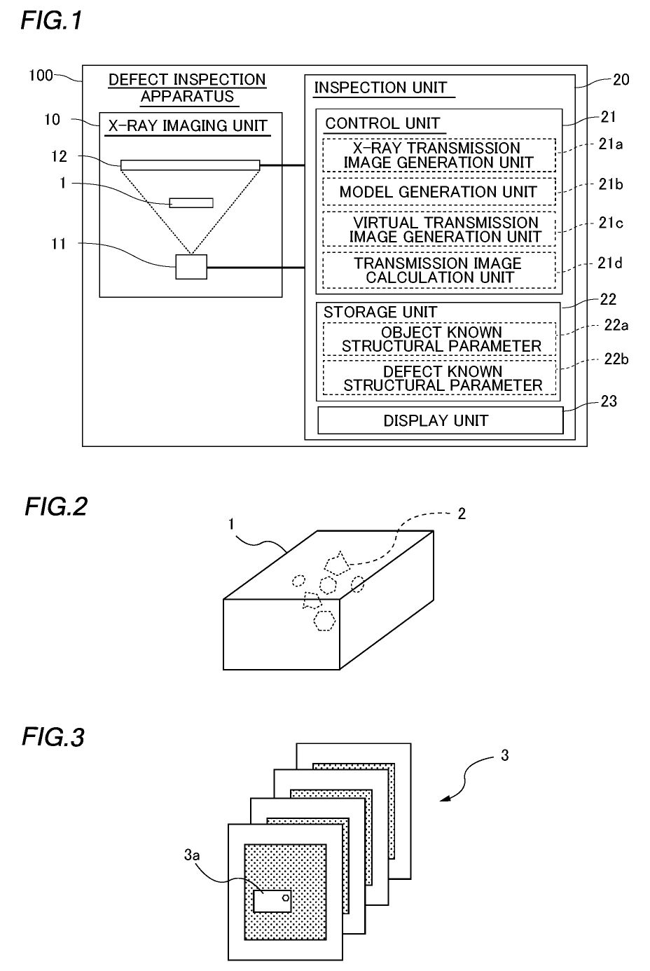

With reference to FIG. 1 to FIG. 6, a defect inspection apparatus 100 according to the first embodiment of the present invention will be described.

As shown in FIG. 1, the defect inspection apparatus 100 according to the first embodiment comprises an X-ray imaging unit 10 and an inspection unit 20. The defect inspection apparatus 100 is a non-destructive inspection apparatus for detecting whether a defect 2 (see FIG. 2) exists inside an object 1, which is an inspection target whose interior cannot be visually recognized, by performing CT (Computed Tomography) imaging. In the defect inspection apparatus 100, each of the X-ray imaging unit 10 and the inspection unit 20 has a communication module, and they transmit and receive information to and from each other via a network or the like. The X-ray imaging unit 10 is an example of the "imaging unit" in the claims, and the defect inspection apparatus 100 is an example of the "X-ray inspection apparatus" in the claims.

As shown in FIG. 2, the object 1 includes a defect 2 inside. The object 1 is made of a material whose transmission image can be acquired by X-ray imaging, such as resin, metal, or ceramic. The defect 2 is a portion that exists unintentionally in the object 1, such as a void. The defect 2 may adversely affect the performance of the object 1, such as its durability.

As shown in FIG. 1, the X-ray imaging unit 10 performs X-ray imaging on the object 1. The X-ray imaging unit 10 has an X-ray irradiation unit 11 and an X-ray detection unit 12. The X-ray irradiation unit 11 is configured to irradiate X-rays. In the first embodiment, the X-ray irradiation unit 11 irradiates X-rays to the object 1 including the defect 2 (see FIG. 2). The object 1 is placed on a rotary table or the like (not shown) and is irradiated with X-rays from various angles. The X-ray irradiation unit 11 includes an X-ray tube that irradiates X-rays by being supplied with electric power from a power supply device (not shown).

The X-ray detection unit 12 is configured to detect the X-rays irradiated from the X-ray irradiation unit 11. The X-ray detection unit 12 outputs an electrical signal corresponding to the detected X-rays. The X-ray detection unit 12 includes, for example, an FPD (Flat Panel Detector), which is an X-ray detector. The X-ray irradiation unit 11 and the X-ray detection unit 12 are arranged inside a housing (not shown) of the X-ray imaging unit 10.

As shown in FIG. 1, the inspection unit 20 has a control unit 21, a storage unit 22, and a display unit 23. The inspection unit 20 is, for example, a personal computer communicably connected to the X-ray imaging unit 10. The control unit 21 includes a processor or circuitry such as a CPU (Central Processing Unit), and ROM (Read Only Memory), RAM (Random Access Memory), and the like. The control unit 21 may also include a processor such as a GPU (Graphics Processing Unit) or an FPGA (Field-Programmable Gate Array) configured for image processing.

Further, the control unit 21 controls the operation of each part of the X-ray imaging unit 10. The control unit 21, for example, controls the irradiation of X-rays by the X-ray irradiation unit 11 by controlling a power supply device (not shown). Thereby, the control unit 21 causes the X-ray imaging unit 10 to perform CT imaging, such as acquiring a plurality of projection data sets captured by irradiating the object 1 (see FIG. 2) with X-rays from multiple directions.

The storage unit 22 is configured to store various programs executed by the control unit 21 and various structural parameters for generating a 3D model of the object 1. Specifically, the storage unit 22 stores, for example, an object known structural parameter 22a and a defect known structural parameter 22b. The storage unit 22 includes, for example, a non-volatile memory such as an HDD (Hard Disk Drive) or an SSD (Solid State Drive).

Here, the object known structural parameter 22a and the defect known structural parameter 22b are, for example, three-dimensional data constituting 3D-CAD data used for designing the object 1, or data that an operator or the like has acquired empirically. Here, in the manufacturing process of the object 1, for example, there are cases where the defect 2 appears in a similar position depending on the manufacturing lot of the object 1, and an operator or the like can empirically acquire that data and prepare it in advance. The 3D-CAD data used for designing the object 1 generally has a smaller (lighter) data capacity than the three-dimensional data generated based on the X-ray projection data 3 (see FIG. 3) obtained by CT imaging.

Further, a display unit 23 is connected to the inspection unit 20. The display unit 23 includes, for example, a liquid crystal monitor. The display unit 23 displays images and character information under the control of the control unit 21. The inspection unit 20 also includes an operation unit (not shown) that accepts input operations by an operator. The operation unit includes, for example, a keyboard and a pointing device such as a mouse.

The control unit 21 includes an X-ray transmission image generation unit 21a, a model generation unit 21b, a virtual transmission image generation unit 21c, and a transmission image calculation unit 21d, which are configured as software functional blocks realized by the control unit 21 executing a program (not shown) stored in the storage unit 22. That is, the program is configured to cause the control unit 21 to execute each control performed by the above functional blocks. These functional blocks may also be configured by providing dedicated processors (processing circuits) and constituted by individual hardware.

The X-ray transmission image generation unit 21a generates X-ray projection data 3 as shown in FIG. 3 based on the X-rays detected by the X-ray detection unit 12. Specifically, the X-ray transmission image generation unit 21a generates X-ray projection data 3 in which the object 1 including the defect 2 is captured as a two-dimensional X-ray transmission image 3a. Further, the X-ray transmission image generation unit 21a is configured to generate a three-dimensional image (rendering image) of the object 1 including the defect 2 by combining a plurality of X-ray projection data sets 3 captured from a plurality of angles while rotating the object 1.

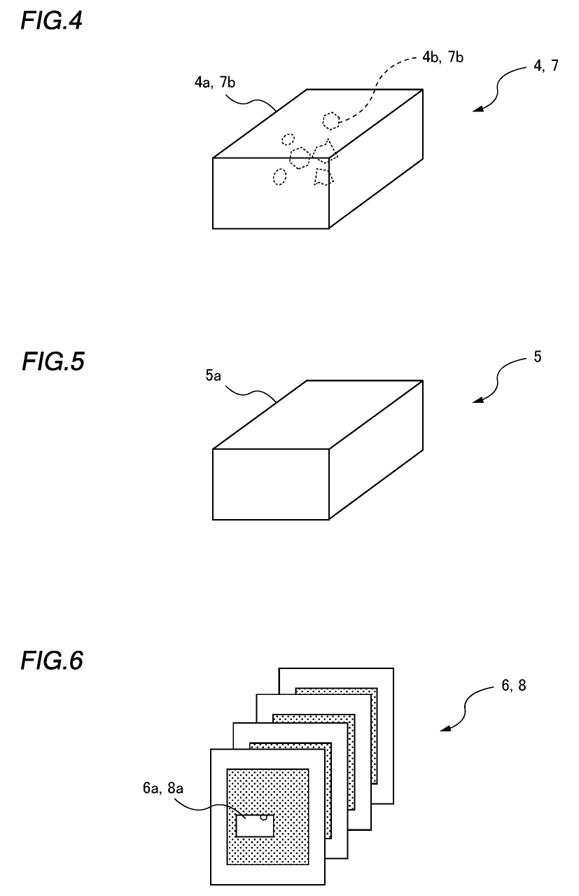

The model generation unit 21b generates a three-dimensional virtual model of the object 1 based on the object known structural parameter 22a and the defect known structural parameter 22b stored in the storage unit 22 as known structural parameters for generating a 3D model. Specifically, the model generation unit 21b generates a three-dimensional virtual model 4 as shown in FIG. 4, corresponding to the object 1. Further, the model generation unit 21b can also generate a defect-free virtual model 5 including a defect-free ideal object 5a that does not include the defect 2, as shown in FIG. 5, based on the object known structural parameter 22a. The virtual model 4 is generated as voxel volume data including a virtual object 4a and a virtual defect 4b.

The virtual transmission image generation unit 21c generates virtual X-ray projection data 6 as shown in FIG. 6 based on the virtual model 4. At this time, the virtual transmission image generation unit 21c generates the virtual X-ray projection data 6 by performing a simulation that reflects the imaging parameters of the X-ray imaging unit 10 used by the X-ray transmission image generation unit 21a to generate the X-ray projection data 3. The imaging parameters include the positions of the X-ray irradiation unit 11 and the X-ray detection unit 12, the tube voltage, tube current, and exposure time of the X-ray irradiation unit 11, and the number of views. Thereby, a two-dimensional virtual transmission image 6a corresponding to the three-dimensional virtual model 4 is obtained.

The transmission image calculation unit 21d is configured to compare the X-ray projection data 3 shown in FIG. 3 and the virtual X-ray projection data 6 shown in FIG. 6 and calculate the difference between them. As comparison result data, the transmission image calculation unit 21d calculates, for example, difference data obtained by finding the difference in luminance for each pixel between the X-ray projection data 3 and the virtual X-ray projection data 6. Further, the transmission image calculation unit 21d calculates data for modifying the structural parameters for generating the virtual model 4, based on the comparison result such as the difference data, in order to make the virtual transmission image 6a captured in the virtual X-ray projection data 6 closer to the X-ray transmission image 3a captured in the X-ray projection data 3.

### Defect Detection Method

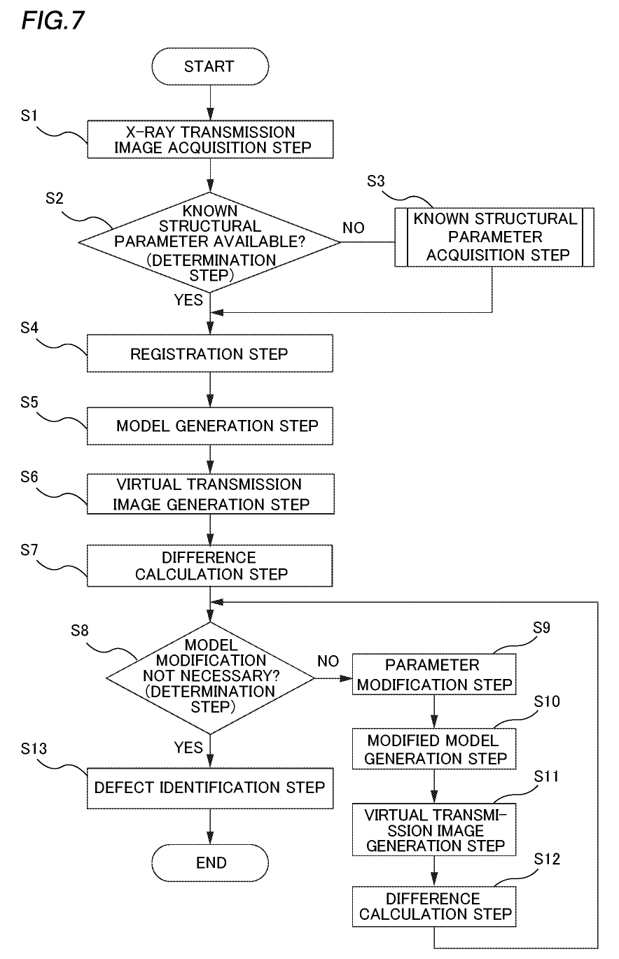

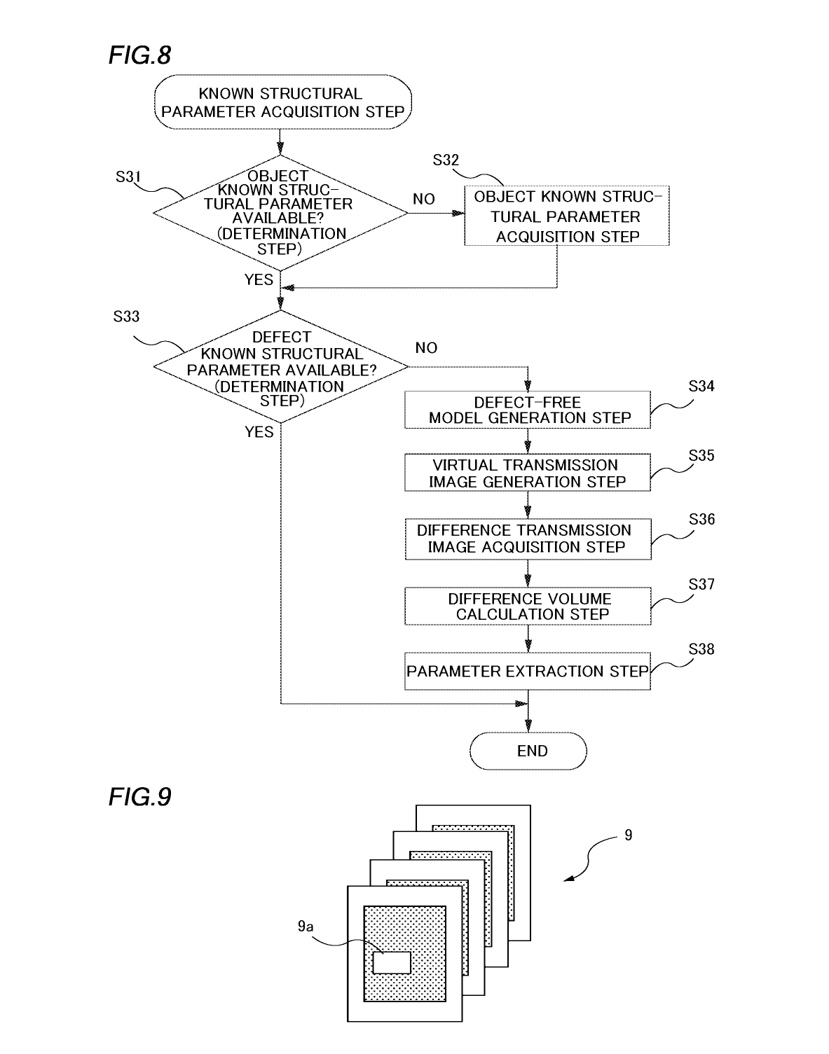

Next, a method by which the control unit 21 (see FIG. 1) detects the defect 2 included in the object 1 will be described according to the flowcharts of FIG. 7 and FIG. 8.

### Case where Known Structural Parameter is Already Acquired

First, in the X-ray transmission image acquisition step of step S1, the control unit 21 (see FIG. 1) acquires a plurality of X-ray projection data sets 3 (see FIG. 3) imaged by the X-ray imaging unit 10. Thereafter, the process proceeds to step S2.

Next, in the determination step of step S2, a determination is made as to whether a known structural parameter is possessed. In this determination step of step S2, if it is confirmed that at least one of the object known structural parameter 22a or the defect known structural parameter 22b is not stored in the storage unit 22 (see FIG. 1), it is determined that a known structural parameter is not possessed, and the process proceeds to step S3. Here, in this determination step of step S2, since the object known structural parameter 22a and the defect known structural parameter 22b are stored in the storage unit 22, it is determined that a known structural parameter is possessed, and the process proceeds to step S4. The process of step S3 will be described later.

Next, in the registration step of step S4, rigid registration of the known structural parameter is performed. A process is performed to align the position of the virtual model 4 (see FIG. 4) generated using the known structural parameter with the imaged object 1 (see FIG. 2). Specifically, in the registration step, the known structural parameter for generating the virtual model 4 is read from the storage unit 22, and information such as the position (coordinates) and posture of the object 1, and the respective positions and angles of the X-ray irradiation unit 11 and the X-ray detection unit 12 with respect to the object 1, is reflected as a structural parameter. Thereafter, the process proceeds to step S5.

Next, in the model generation step of step S5, a three-dimensional virtual model 4 (see FIG. 4) is generated based on the known structural parameter on which rigid registration has been performed. Here, in the first embodiment, the virtual object 4a is generated based on 3D-CAD data as the object known structural parameter 22a, and the virtual defect 4b is generated based on 3D-CAD data for which coordinates and size have been set as the defect known structural parameter 22b based on past knowledge of an operator or the like. Since the virtual model 4 is generated based on 3D-CAD data, there are no artifacts associated with CT imaging. Therefore, the virtual object 4a and the object 1 may not exactly match at this stage, and the virtual defect 4b and the defect 2 may also not exactly match at this stage. Thereafter, the process proceeds to step S6.

Next, in the virtual transmission image generation step of step S6, a two-dimensional virtual transmission image 6a (see FIG. 6) is generated based on the three-dimensional virtual model 4 (see FIG. 4). The virtual transmission image 6a is an image captured in virtual X-ray projection data 6, which is generated by a simulation applying the imaging parameters corresponding to the X-ray transmission image 3a, and the number of generated virtual X-ray projection data 6 corresponds to the number of X-ray projection data 3 in which the X-ray transmission image 3a is captured. The simulation is executed by, for example, an X-ray tomography simulator such as ASTRA Toolbox. Thereafter, the process proceeds to step S7.

Next, in the difference calculation step of step S7, difference data between the X-ray transmission image 3a and the virtual transmission image 6a is calculated. For example, the calculation of difference data that determines the difference in luminance for each pixel between the X-ray projection data 3 (see FIG. 3) and the virtual X-ray projection data 6 (see FIG. 6) is performed. Thereafter, the process proceeds to step S8.

Next, in the determination step of step S8, a determination is made as to whether modification of the virtual model 4 (see FIG. 4) is necessary. The modification of the virtual model 4 includes calculating the voxel values of the 3D voxel volume constituting the virtual model 4.

Here, in this determination step of step S8, for example, the L2 norm (sum of squared differences between the X-ray transmission image 3a and the virtual transmission image 6a), which indicates the degree of similarity between the X-ray transmission image 3a and the virtual transmission image 6a, is calculated, and if the L2 norm is smaller than a predetermined threshold, it is determined that modification of the virtual model 4 is unnecessary, and the process proceeds to step S13. In the first embodiment, the virtual object 4a is generated based on the 3D-CAD data used for designing the object 1 and is quite similar, but the virtual defect 4b is set based on empirical information of an operator or the like, so the degree of similarity is not that high. Therefore, an example will be described in which the L2 norm indicating the degree of similarity between the X-ray transmission image 3a and the virtual transmission image 6a is equal to or greater than the predetermined threshold, and the process proceeds to step S9 as modification of the virtual model 4 is necessary.

Next, in the parameter modification step of step S9, the structural parameters for generating the virtual model 4 are modified so as to make the virtual model 4 closer to the object 1. Specifically, the control unit 21 refers to the difference data and performs an optimization process to modify the structural parameters so as to make the shape, position (coordinates), material, and size of the virtual object 4a of the virtual model 4, and the shape, position (coordinates), material, size, and number of the virtual defect 4b closer to the object 1. At this time, the modification of the structural parameters does not need to modify the parameters of the entire three-dimensional virtual model, but the parameters of the different parts between the X-ray transmission image 3a and the virtual transmission image 6a are modified based on the difference data. Thereafter, the process proceeds to step S10.

Next, in the modified model generation step of step S10, a three-dimensional modified virtual model 7 as shown in FIG. 4 is generated based on the structural parameters that have been modified based on the difference data. In the generated modified virtual model 7, since the parameters of the different parts between the X-ray transmission image 3a and the virtual transmission image 6a have been modified for each of the modified virtual object 7a and the modified virtual defect 7b, the degree of similarity with the object 1 and the defect 2 is improved. Thereafter, the process proceeds to step S11.

Next, in the modified virtual transmission image generation step of step S11, modified virtual projection data 8 including a two-dimensional modified virtual transmission image 8a is generated based on the three-dimensional modified virtual model 7 (see FIG. 4). The modified virtual transmission image 8a is also generated by a simulation applying the imaging parameters corresponding to the X-ray transmission image 3a (see FIG. 3), similar to the generation of the virtual transmission image 6a, and the number of generated images corresponds to the number of X-ray transmission images 3a. Thereafter, the process proceeds to step S12.

Next, in the difference calculation step of step S12, similar to the difference calculation step of step S7, difference data between the X-ray transmission image 3a (see FIG. 3) and the modified virtual transmission image 8a (see FIG. 6) is calculated. Thereafter, the process returns to step S8. By repeating the steps from S8 to S12, the virtual model 4 (see FIG. 4) is made closer to the object 1. Similarly, the position (coordinates), size, and shape of the virtual defect 4b in the virtual model 4 are also made closer to the position (coordinates), size, and shape of the defect 2 in the object 1.

Next, an example will be described in which, by repeating the steps from S8 to S12, it is determined in the difference calculation step of step S8 that model modification of the modified virtual model 7 is not necessary, and the process proceeds to the defect identification step of step S13.

In the defect identification step of step S13, at least one of the position (coordinates), shape, and size of the defect 2 with respect to the object 1 is identified. In the first embodiment, all of the position (coordinates), shape, and size of the defect 2 with respect to the object 1 are identified. Here, since the modified virtual model 7 has a high degree of similarity with the object 1, by identifying the position (coordinates), shape, and size of the modified virtual defect 7b, the position (coordinates), shape, and size of the defect 2 in the object 1 are substantially identified. In the first embodiment, since the modified virtual defect 7b is directly identified as described above, there is no need to perform a separate process for extracting the defect 2 from the entire three-dimensional model of the object 1 including the defect 2, as in the prior art.

In the defect identification step of step S13, at least one or all of the position (coordinates), shape, and size of the defect 2 with respect to the object 1 are displayed as list data on the display unit 23 (see FIG. 1), and the modified virtual defect 7b corresponding to the defect 2 is displayed on the three-dimensional modified virtual model 7 so as to be distinguishable from the modified virtual object 7a. Thereby, not only the control unit 21 but also an operator or the like can identify (detect) the defect 2. With the above steps, the process of defect inspection (X-ray inspection) is completed.

### Case where Known Structural Parameter is Not Acquired

Next, an example will be described in which it is determined in the determination step of step S2 that there is no known structural parameter, and the process proceeds to step S3. For parts common to steps S1 to S13 described above, the description will be omitted.

In the determination step of step S2 shown in FIG. 7, a determination is made as to whether a known structural parameter is possessed. In this determination step of step S2, if it is confirmed that at least one of the object known structural parameter 22a or the defect known structural parameter 22b is not stored in the storage unit 22 (see FIG. 1), it is determined that a known structural parameter is not possessed, and the process proceeds to step S3. Here, it is assumed that the storage unit 22 stores the object known structural parameter 22a as a known structural parameter, but does not store the defect known structural parameter 22b, and the process proceeds to step S3.

In the known structural parameter acquisition step of step S3, the control unit 21 is configured to acquire the known structural parameters of the object 1 and the defect 2. Here, the details of the known structural parameter acquisition step will be described using the flowchart of FIG. 8. This known structural parameter acquisition step of step S3 needs to be performed only once for the first inspection of the object 1 to be inspected and stored in the storage unit 22, and does not need to be performed for every subsequent inspection of the object 1.

As shown in FIG. 8, in the determination step of step S31, first, a determination is made as to whether a known structural parameter of the object 1 is possessed. Specifically, in this determination step of step S31, if it is confirmed that the object known structural parameter 22a is not stored in the storage unit 22 (see FIG. 1), it is determined that the object known structural parameter 22a is not possessed, and the process proceeds to step S32. In the object known structural parameter acquisition step of step S32, three-dimensional data is acquired using a method similar to the prior art, such as rendering a three-dimensional model from CT imaging, and the object known structural parameter 22a is acquired based on the obtained three-dimensional data. In the first embodiment, it is assumed that the storage unit 22 stores the object known structural parameter 22a as a known structural parameter, and the process proceeds to step S33.

Next, in the determination step of step S33, a determination is made as to whether a known structural parameter of the defect 2 is possessed. Specifically, in this determination step of step S33, if it is confirmed that the defect known structural parameter 22b is stored in the storage unit 22 (see FIG. 1), it is determined that the defect known structural parameter 22b is possessed, and the known structural parameter acquisition step is completed. In the first embodiment, an example will be described in which, by confirming that the defect known structural parameter 22b is not stored in the storage unit 22 (see FIG. 1), it is determined that the defect known structural parameter 22b is not possessed, and the process proceeds to step S34.

Next, in the defect-free model generation step of step S34, a three-dimensional defect-free virtual model 5 of the object 1 (see FIG. 5) is generated, assuming that it does not include the defect 2. In the defect-free model generation step of step S34, for example, if there is CAD data used for designing the object 1, a three-dimensional defect-free virtual model 5 is generated using that CAD data. If there is no CAD data used for designing the object 1, for example, an operator or the like modifies the portion corresponding to the defect 2 from the three-dimensional data of the object 1 acquired in step S32 or the like to generate a three-dimensional defect-free virtual model 5 with the portion corresponding to the defect 2 removed. Thereafter, the process proceeds to step S35.

In the virtual transmission image generation step of step S35, a two-dimensional defect-free virtual transmission image 9a (see FIG. 9) is generated based on the three-dimensional defect-free virtual model 5 (see FIG. 5). The defect-free virtual transmission image 9a is an image captured in defect-free virtual projection data 9, which is generated by a simulation applying the imaging parameters corresponding to the X-ray transmission image 3a, and the number of generated images corresponds to the number of X-ray projection data 3 in which the X-ray transmission image 3a is captured. Thereafter, the process proceeds to step S36.

In the difference transmission image acquisition step of step S36, a difference between the X-ray transmission image 3a (see FIG. 3) and the defect-free virtual transmission image 9a (see FIG. 9) is acquired. This difference includes a difference transmission image (not shown), and includes, for example, an image constituted by the difference value in luminance for each pixel between the X-ray transmission image 3a and the defect-free virtual transmission image 9a. Here, since the defect-free virtual transmission image 9a does not have a portion corresponding to the defect 2, the difference transmission image with the X-ray transmission image 3a substantially displays the defect 2. However, at this point, sufficient accuracy for performing defect inspection may not be obtained due to the influence of noise or the like during the acquisition of the X-ray transmission image 3a. Thereafter, the process proceeds to step S37.

Next, in the difference volume calculation step of step S37, a volume calculation for generating a three-dimensional difference virtual model (not shown) is performed based on the difference transmission image obtained in step S36. That is, data such as the position (coordinates), size, and shape of the portion corresponding to the defect 2, which is necessary for generating the three-dimensional difference virtual model (not shown), is calculated. Thereafter, the process proceeds to step S38.

Next, in the parameter extraction step of step S38, data such as the position (coordinates), size, and shape of the portion corresponding to the defect 2, which is necessary for generating the three-dimensional difference virtual model (not shown), is extracted as the defect known structural parameter 22b (see FIG. 1). Thereby, the known structural parameter acquisition step is completed.

Further, by the above steps, the object known structural parameter 22a and the defect known structural parameter 22b are acquired, so that they can be used as known structural parameters for defect inspection. Therefore, the steps from S4 to S13 shown in FIG. 7 can be performed, and defect inspection (X-ray inspection) can be performed based on the known structural parameters.

### Second Embodiment

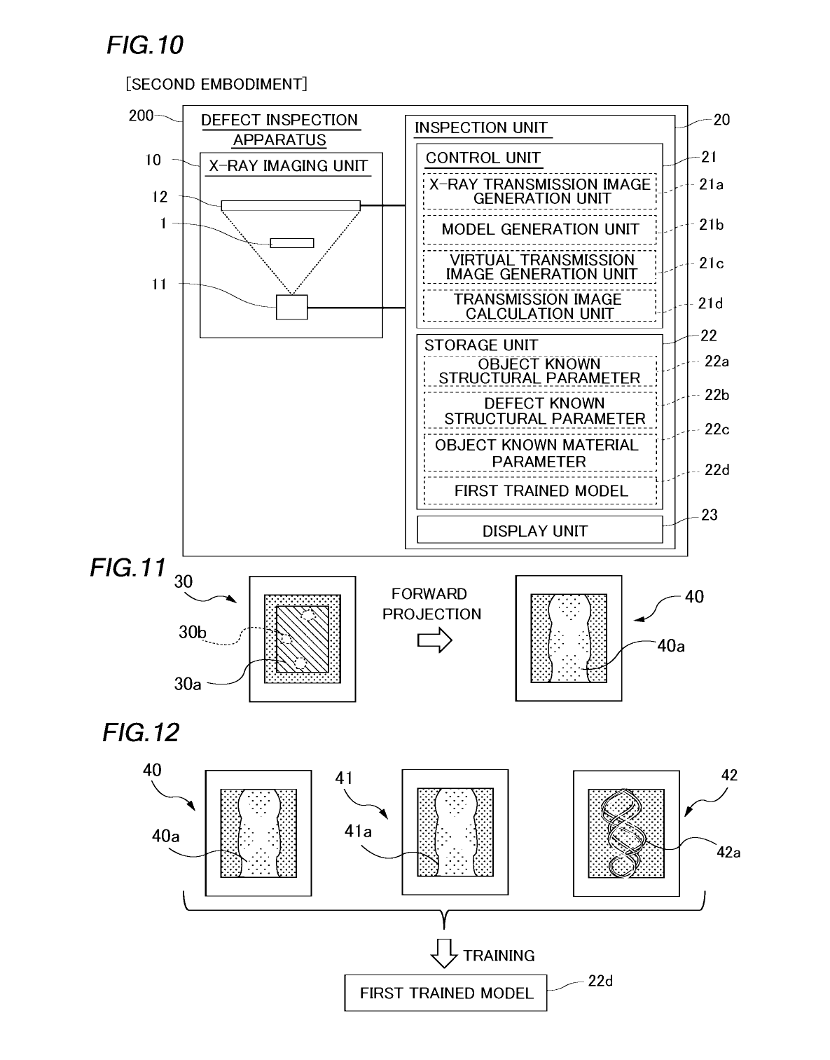

Next, a second embodiment of the present invention will be described with reference to FIG. 10 to FIG. 16. First, the configuration of a defect inspection apparatus 200 will be described using FIG. 10. In this second embodiment, an example will be described in which, as shown in FIG. 10, the storage unit 22 of the defect inspection apparatus 200 stores an object known material parameter 22c and a first trained model 22d. In the second embodiment, description of points common to the first embodiment will be omitted.

The object known material parameter 22c is information that an operator or the like has acquired in advance regarding the material constituting the object 1 (see FIG. 2). The object known material parameter 22c includes information such as the material type, specific gravity, and linear attenuation coefficient of the object 1. If the object 1 is formed by combining a plurality of different materials, the object known material parameter 22c includes information such as the material type, specific gravity, and linear attenuation coefficient for each material.

Here, since the object known material parameter 22c is stored, the model generation unit 21b can generate a virtual model 4 (see FIG. 4) that reflects the linear attenuation coefficient representing the degree of X-ray attenuation that differs for each material constituting the object 1 (see FIG. 2). In the second embodiment, the object 1 is formed, for example, by combining a resin material and a metal material. Therefore, the virtual object 4a, which is a model of the object 1, also becomes a model in which a resin material and a metal material are combined. The virtual model 4 also includes a virtual defect 4b.

At this time, the virtual transmission image generation unit 21c can generate a virtual tomographic image 30a, which is a tomographic view of the virtual model 4 reflecting the linear attenuation coefficient, as shown in FIG. 11. The virtual tomographic image 30a includes a singular part 30b whose linear attenuation coefficient is significantly different from other parts. The singular part 30b is, for example, a part where a metal material (not shown) included in the virtual model 4 is arranged. The virtual transmission image generation unit 21c generates first training projection data 40 as a sinogram by performing forward projection of the virtual tomographic image 30a in a simulation. The first training projection data 40 includes a first training transmission image 40a that contains a metal artifact generated by performing a (virtual) projection process on a metal material (not shown), in addition to information regarding the defect.

Next, the first trained model 22d will be described. The first trained model 22d performs an inference process using a fully convolutional neural network. The first trained model 22d is a trained model that takes two-dimensional X-ray projection data 3 (see FIG. 3) and two-dimensional virtual X-ray projection data 6 (see FIG. 6) as input data and outputs two-dimensional detection defect projection data 50 (see FIG. 15) as output data. The first trained model 22d is an example of the "trained model" in the claims. The first trained model 22d has been trained in advance to output the detection defect projection data 50 and the like.

Specifically, as shown in FIG. 12, the first trained model 22d has been trained in advance with a data set consisting of first training projection data 40, second training projection data 41, and first training defect projection data 42. In FIG. 12, for simplification, one of each of the first training projection data 40, the second training projection data 41, and the first training defect projection data 42 is shown, but in reality, the first trained model 22d has learned a plurality of each of the first training projection data 40, the second training projection data 41, and the first training defect projection data 42.

The second training projection data 41 is generated by the virtual transmission image generation unit 21c based on, for example, the defect-free virtual model 5. In the second embodiment, the defect-free virtual model 5 is generated by the virtual transmission image generation unit 21c so as not to include the part related to the virtual defect 4b of the virtual model 4. Therefore, the second training transmission image 41a of the generated second training projection data 41 includes a metal artifact derived from a metal material (not shown), but does not include information regarding the defect.

The first training defect projection data 42 is generated by obtaining the difference value between the first training projection data 40, which includes the artifact derived from the metal material and information regarding the defect, and the second training projection data 41, which includes the artifact derived from the metal material but does not include information regarding the defect. That is, in the first training defect transmission image 42a included in the first training defect projection data 42, only the part related to the virtual defect 4b of the virtual model 4 remains, and the metal artifact derived from the metal material (not shown) is not included. The first training defect projection data 42 may also be generated by virtually back-projecting (reconstructing) only the virtual defect 4b of the virtual model 4 used for generating the first training projection data 40, as a model. The first trained model 22d may be trained in a state where the arrangement states, such as the positions and angles, of the first training projection data 40 and the second training projection data 41 are not accurately matched.

### Defect Detection Method

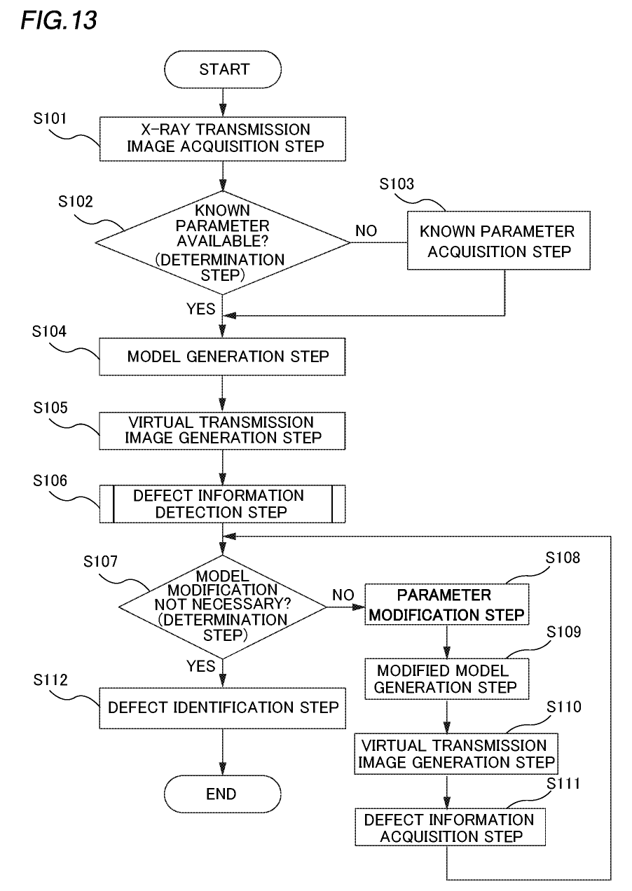

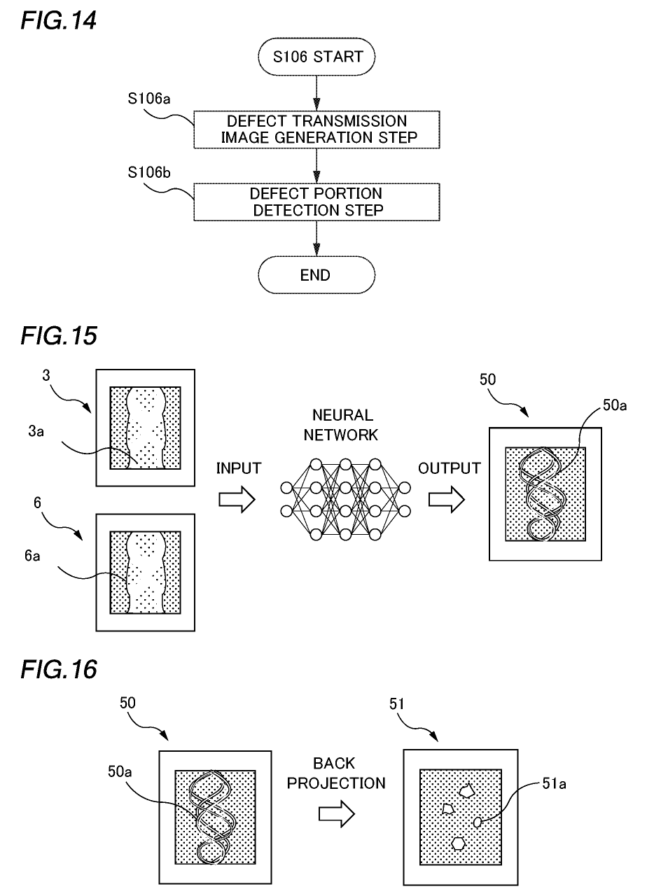

Next, a method by which the control unit 21 (see FIG. 10) detects the defect 2 included in the object 1 will be described according to the flowcharts of FIG. 13 and FIG. 14. In the flowchart of FIG. 13, steps with the same names as those in the flowchart of the first embodiment shown in FIG. 7 perform the same processes as in the first embodiment, so a part of the description will be omitted.

After the control unit 21 (see FIG. 10) acquires the X-ray projection data 3 (see FIG. 15) in step S101, the control unit 21 determines whether it has a known parameter in step S102. In the second embodiment, a case will be described where the object known structural parameter 22a, the defect known structural parameter 22b, and the object known material parameter 22c are possessed as known parameters. In this case, the control unit 21 determines that it has a known parameter (step S102: Yes), and the process proceeds to step S104.

Next, in the model generation step of step S104, a three-dimensional virtual model 4 (see FIG. 4) is generated based on the object known structural parameter 22a, the defect known structural parameter 22b, and the object known material parameter 22c. Here, the virtual model 4 is a model in which a metal material (not shown) and a resin material are combined. The virtual object 4a and the object 1 may not exactly match at this stage, and the virtual defect 4b and the defect 2 may also not exactly match at this stage. Thereafter, the process proceeds to step S105.

In step S105, the virtual transmission image generation unit 21c (see FIG. 10) generates virtual X-ray projection data 6 (see FIG. 15) based on the virtual model 4. At this time, since the virtual X-ray projection data 6 is generated based on the linear attenuation coefficient distribution 30 as a tomographic view of the 3D-CAD data (virtual model 4), an artifact (metal artifact) associated with the virtual X-ray projection exists.

In the defect information detection step of step S106, the transmission image calculation unit 21d (see FIG. 10) detects information for identifying the defect 2 in the object 1. Here, in the defect information detection step of step S106, the process is executed by the control unit 21 (transmission image calculation unit 21d) according to the flow of the sub-flowchart shown in FIG. 14.

In the defect transmission image generation step of step S106a shown in FIG. 14, the transmission image calculation unit 21d calls the first trained model 22d from the storage unit 22, as shown in FIG. 15, and causes it to calculate detection defect projection data 50 as output data based on the X-ray projection data 3 and the virtual X-ray projection data 6 as input data. At this time, since the first trained model 22d has been trained in a state where the arrangement states, such as the positions and angles, of the first training projection data 40 (see FIG. 12) and the first training defect projection data 42 (see FIG. 12) are not accurately matched, the first trained model 22d can appropriately calculate the detection defect projection data 50 even if the arrangement states of the X-ray projection data 3 and the virtual X-ray projection data 6 are slightly misaligned. Thereby, a detection defect transmission image 50a, which is information of the defect 2 with the influence of metal artifacts removed, is acquired. Thereafter, the process proceeds to step S106b.

In the defect portion detection step of step S106b, the transmission image calculation unit 21d generates detection defect tomographic data 51 by virtually back-projecting (reconstructing) the detection defect projection data 50 through a simulation, as shown in FIG. 16. The detection defect tomographic data 51 is, for example, a tomographic image in which a defect portion 51a is displayed, and indicates the position of the defect 2 in the tomographic image. Thereafter, the process proceeds to step S107.

In the determination step of step S107, a determination is made as to whether modification of the virtual model 4 (see FIG. 4) is necessary. The control unit 21 determines, for example, the necessity of modifying the virtual model 4 from the number and size of the defect portions 51a. If modification of the virtual model 4 is necessary, the process proceeds to step S108, and if modification is not necessary, the process proceeds to step S112. The processes from step S108 to step S112 are the same as the processes from step S8 to step S13 in the flowchart shown in FIG. 7. Through the above processing, it becomes possible to perform defect inspection with the influence of artifacts suppressed.

### Third Embodiment

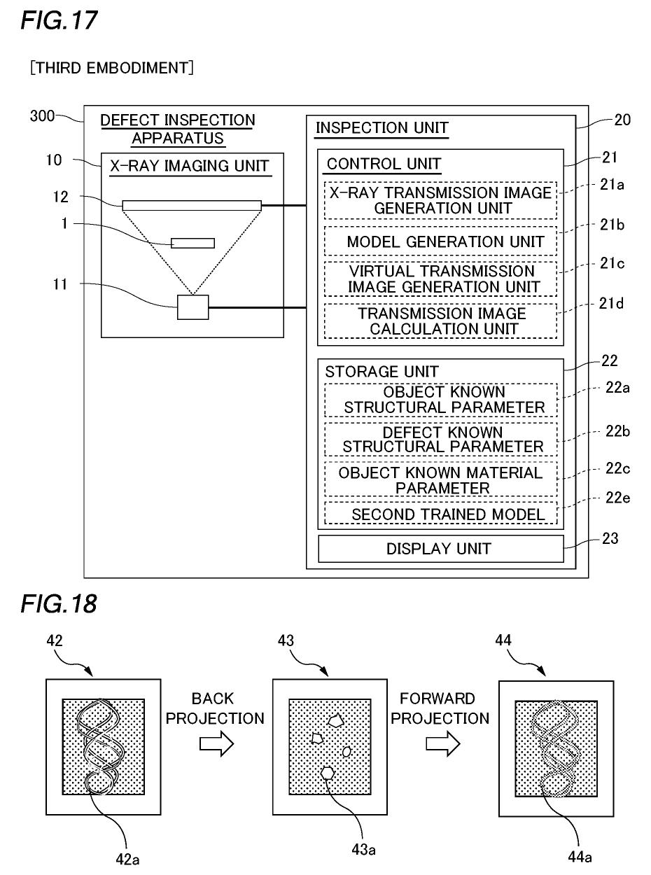

Next, a third embodiment of the present invention will be described with reference to FIG. 17 to FIG. 26. First, the configuration of a defect inspection apparatus 300 will be described using FIG. 17. In this third embodiment, an example will be described in which, as shown in FIG. 17, the storage unit 22 of the defect inspection apparatus 300 stores a second trained model 22e. In the third embodiment, description of points common to the first and second embodiments will be omitted.

The second trained model 22e will be described. The second trained model 22e performs an inference process using a fully convolutional neural network. As shown in FIG. 2, the second trained model 22e is a trained model that takes two-dimensional X-ray projection data 3 (see FIG. 3) and two-dimensional virtual X-ray projection data 6 (see FIG. 6) as input data and outputs two-dimensional first detection defect projection data 60 (see FIG. 23) as output data. The second trained model 22e is an example of the "trained model" in the claims. The second trained model 22e has been trained in advance to output the first detection defect transmission image 60a and the like.

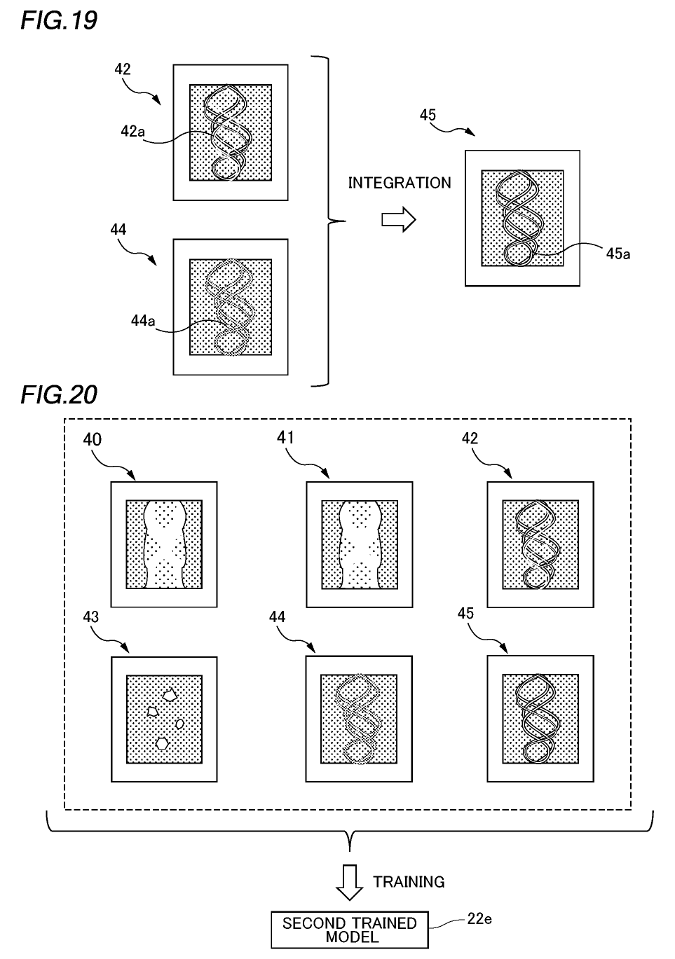

Here, the second trained model 22e has also learned another group of data generated based on the first training defect projection data 42, in addition to the training data (first training projection data 40, second training projection data 41, and first training defect projection data 42) that the first trained model 22d described in the second embodiment learns. Specifically, as shown in FIG. 18, the second trained model 22e also learns training defect tomographic data 43, which is obtained by virtually back-projecting the first training defect projection data 42 through a simulation, and second training defect projection data 44, which is obtained by virtually forward-projecting the training defect tomographic data 43 through a simulation. Further, as shown in FIG. 19, the second trained model 22e also learns about third training defect projection data 45, which is generated by integrating the first training defect projection data 42 and the second training defect projection data 44. The third training defect projection data 45 is generated, for example, by averaging the first training defect projection data 42 and the second training defect projection data 44.

That is, as shown in FIG. 20, the second trained model 22e has learned a data set consisting of the first training projection data 40, the second training projection data 41, the first training defect projection data 42, the training defect tomographic data 43, the second training defect projection data 44, and the third training defect projection data 45. A plurality of each of these training data sets is prepared. Further, the second trained model 22e has learned by weighting each of the first training defect projection data 42, the training defect tomographic data 43, the second training defect projection data 44, and the third training defect projection data 45 at a ratio set in advance by a user or the like. The weighting (ratio) for each training data may be set automatically through training or the like.

### Defect Detection Method

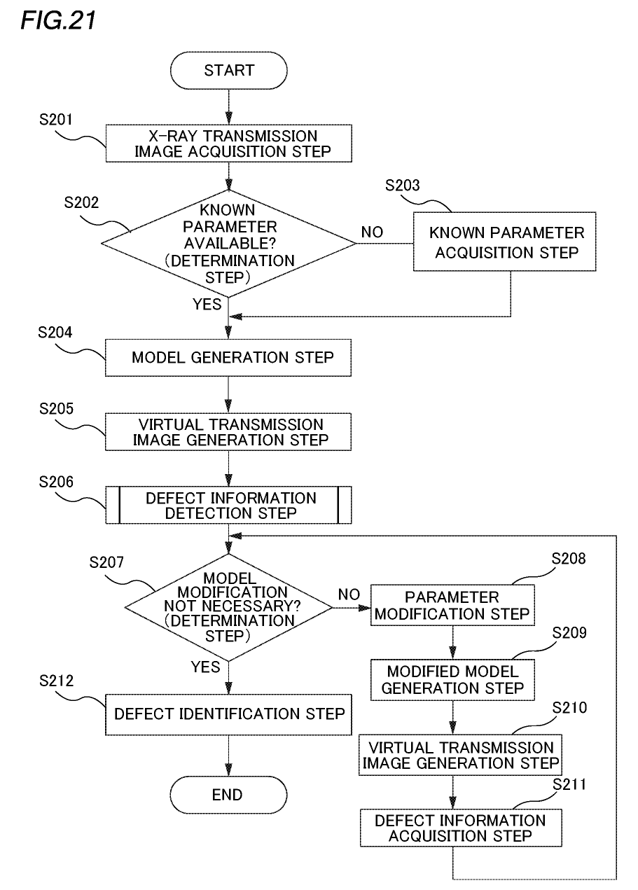

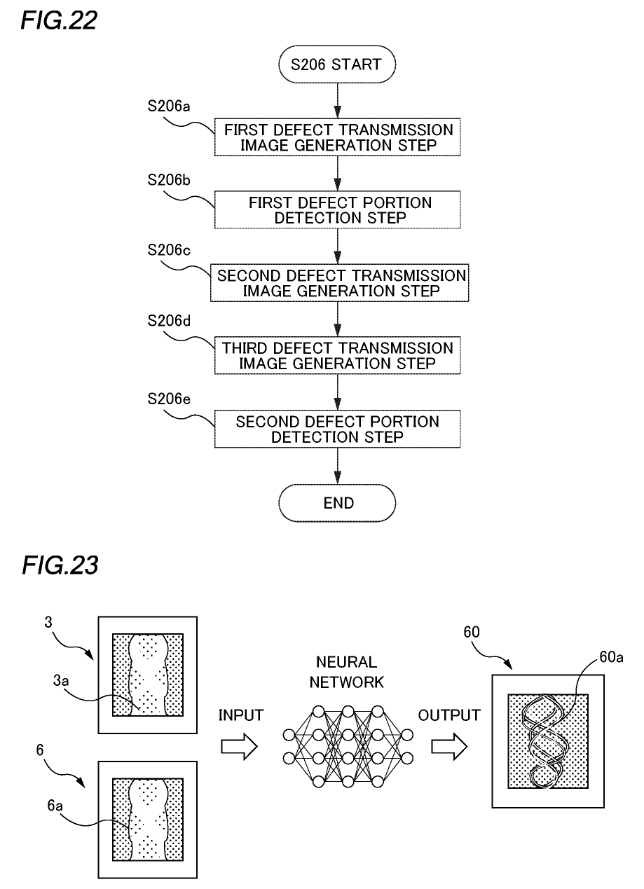

Next, a method by which the control unit 21 (see FIG. 17) detects the defect 2 included in the object 1 will be described according to the flowcharts of FIG. 21 and FIG. 22. In the flowchart of FIG. 21, steps with the same names as those in the flowcharts of the first and second embodiments shown in FIG. 7 and FIG. 13 perform the same processes as in the first and second embodiments, so a part of the description will be omitted.

In steps S201 to S205 of the flowchart in FIG. 21, the same processes as in steps S101 to S105 of the flowchart of the second embodiment shown in FIG. 13 are performed. In the subsequent defect information detection step of step S206, the transmission image calculation unit 21d (see FIG. 17) detects information for identifying the defect 2 in the object 1. Here, in the defect information detection step of step S206, the process is executed by the control unit 21 (transmission image calculation unit 21d) according to the flow of the sub-flowchart shown in FIG. 22.

In the first defect transmission image generation step of step S206a shown in FIG. 18, the transmission image calculation unit 21d calls the second trained model 22e from the storage unit 22, as shown in FIG. 23, and causes it to calculate first detection defect projection data 60 as output data based on the X-ray projection data 3 and the virtual X-ray projection data 6 as input data. At this time, since the second trained model 22e has learned the training defect tomographic data 43, the second training defect projection data 44, and the third training defect projection data 45 in addition to the first training defect projection data 42, it is possible to generate first detection defect projection data 60 that represents the transmission image (first detection defect transmission image 60a) with higher accuracy than the detection defect projection data 50 generated in step S106a of the second embodiment. When the object 1 has a complex structure, the contrast of the X-ray projection data 3 input to the second trained model 22e may become low, and a delicate defect may not be reflected in the first detection defect transmission image 60a output by the second trained model 22e (a discontinuous portion may occur). Thereafter, the process proceeds to step S206b. The first detection defect transmission image 60a is an example of the "first defect transmission image" in the claims.

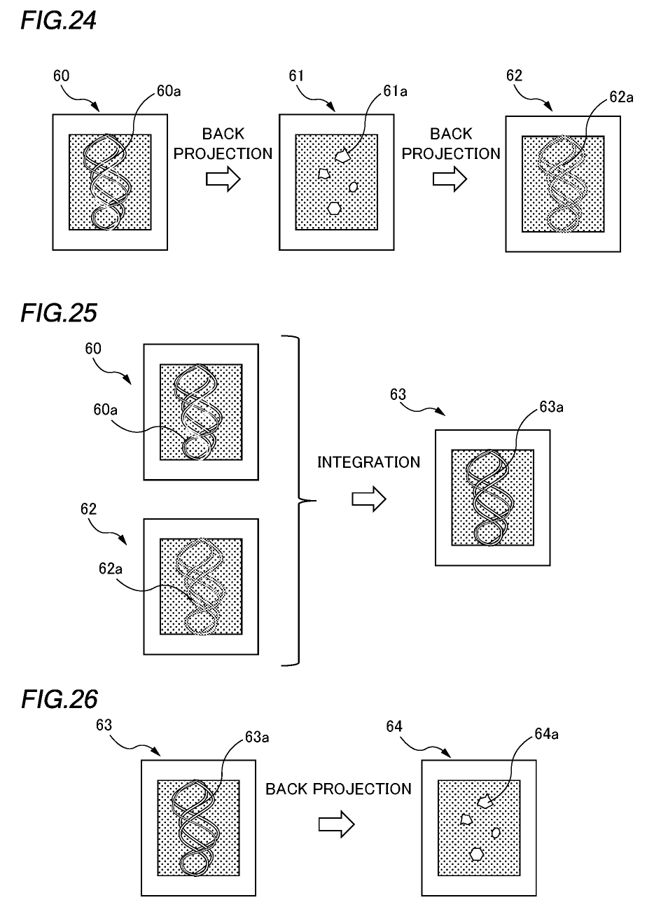

In the first defect portion detection step of step S206b, the transmission image calculation unit 21d generates first defect tomographic data 61 by virtually back-projecting (reconstructing) the first detection defect projection data 60 through a simulation, as shown in FIG. 24. The first defect tomographic data 61 is, for example, a two-dimensional tomographic image in which a defect portion 61a is displayed. Thereafter, the process proceeds to step S206c.

In the second defect transmission image generation step of step S206c, the transmission image calculation unit 21d generates second detection defect projection data 62 by virtually forward-projecting the first defect tomographic data 61 through a simulation, as shown in FIG. 24. A second detection defect transmission image 62a is displayed in the second detection defect projection data 62. The discontinuity in the second detection defect transmission image 62a has been resolved compared to the first detection defect transmission image 60a due to the back projection and forward projection performed on the first defect tomographic data 61, but artifacts such as blur may remain. Thereafter, the process proceeds to step S206d. The second detection defect transmission image 62a is an example of the "second defect transmission image" in the claims.

In the third defect transmission image generation step of step S206d, the transmission image calculation unit 21d generates third detection defect projection data 63 by performing an integration process (for example, an averaging process) on the first detection defect projection data 60 and the second detection defect projection data 62, as shown in FIG. 25. The third detection defect transmission image 63a displayed in this third detection defect projection data 63 is in a state where artifacts such as blur are suppressed while maintaining continuity. Thereafter, the process proceeds to step S206e. The third detection defect transmission image 63a is an example of the "third defect transmission image" in the claims.

In the second defect portion detection step of step S206e, the transmission image calculation unit 21d generates second defect tomographic data 64 by virtually back-projecting (reconstructing) the third detection defect projection data 63 through a simulation, as shown in FIG. 26. The second defect tomographic data 64 is, for example, a tomographic image in which a defect portion 64a is displayed. Thereafter, the process proceeds to step S207. The processes from step S207 to step S212 are the same as the processes from step S107 to step S112 in the flowchart shown in FIG. 13. Through the above processing, it becomes possible to perform defect inspection with the influence of artifacts suppressed.

### Modifications

It should be understood that the embodiments disclosed this time are illustrative in all respects and not restrictive. The scope of the present invention is indicated by the claims rather than the description of the embodiments above, and all changes (modifications) within the meaning and scope equivalent to the claims are included.

For example, the known structural parameter may be configured to include at least one of the object known structural parameter 22a or the defect known structural parameter 22b of a known defect 2 existing in the object 1.

Also, for example, in the parameter modification steps of S9, S108, and S209, not only the structural parameters of the different parts between the two-dimensional X-ray transmission image 3a and the two-dimensional virtual transmission image 6a but also the entire structural parameters of the three-dimensional virtual model 4 may be modified.

Also, for example, after the parameter modification steps of S9, S108, and S209, a defect identification step of displaying any of the position, shape, or size of the defect 2 with respect to the object 1 may be provided, or the defect identification step itself may not be provided, and an operator or the like may be configured to determine and identify the defect 2.

Also, for example, the defect identification steps of S13, S112, and S212 may be configured to display the position, shape, and size of the defect 2 with respect to the object 1 in either one of a display format as list data or distinguishably from the corresponding part of the object on the modified virtual model 7.

Also, for example, after the defect identification steps of S13, S112, and S212, a step of determining whether the object 1 is a non-defective product or a defective product based on the position, shape, or size of the defect 2 with respect to the object 1 may be provided.

Also, for example, the virtual transmission image generation steps of S6, S105, and S205 may be configured to generate the two-dimensional virtual transmission image 6a from the three-dimensional virtual model 4 under the same conditions each time, without performing a simulation that reflects the imaging parameters used in the X-ray transmission image acquisition steps of S1, S101, and S201. In that case, a step of correcting the deviation between the imaging parameters and the simulation conditions (parameters) is preferably performed.

Also, for example, as the known structural parameter acquisition step, instead of using the difference obtained by comparing the X-ray transmission image 3a and the two-dimensional defect-free virtual transmission image 9a that does not include the defect 2, the defect known structural parameter 22b obtained from past experimental data and inspection results of an operator or the like may be configured to be input.

Also, for example, the three-dimensional virtual model 4, the modified virtual model 7, and the difference virtual model (not shown) generated by the model generation unit 21b may be generated not as a voxel volume model but as a mesh model with a lighter data amount.

Also, the index indicating the degree of similarity between the X-ray transmission image 3a and the virtual transmission image 6a used in the determination step of step S8 may be a similarity other than the L2 norm. For example, the cosine similarity between the X-ray transmission image 3a and the virtual transmission image 6a may be used.

Also, in the determination step of step S8, the determination of whether modification of the virtual model 4 (see FIG. 4) is necessary may be determined not by whether the similarity is smaller than a predetermined threshold but by whether a number of modification repetitions set in advance by an operator or the like has been met.

Also, the object 1 may be formed of one type of material, such as only a resin material. Also, the model generation unit 21b may generate the virtual model 4 without using a known material parameter.

Also, the model generation unit 21b may generate the two-dimensional virtual transmission image based on a tomographic view generated using an index other than the linear attenuation coefficient distribution representing the degree of X-ray attenuation that differs for each material.

Also, even when the process of generating the virtual model 4 using the known material parameter and identifying the defect is performed as in the second and third embodiments, the process may be performed without using a trained model. Also, even when the defect identification process as in the first embodiment is performed, the process may be performed using a trained model.

Also, in the defect information acquisition steps of S106 and S206, the information of the defect with respect to the object 1 may be detected based on the second defect transmission image.

Also, the trained model may learn any one or two of the training defect tomographic data 43, the second training defect projection data 44, and the third training defect projection data 45, without learning all of them.

Also, the trained model may learn each of the first training defect projection data 42, the training defect tomographic data 43, the second training defect projection data 44, and the third training defect projection data 45 without weighting.

Also, the third detection defect projection data 63 may be generated by linear addition of the first detection defect projection data 60 and the second detection defect projection data 62, without averaging them. Also, the third detection defect projection data 63 may be generated by having a trained model read the first detection defect projection data 60 and the second detection defect projection data 62 on a pixel basis or on a unit where a filter is applied to each pixel (pixel feature unit), and performing inference using a neural network.

Also, when calculating the virtual X-ray projection data 6 using the known material parameter, if the positions of different materials in the X-ray transmission image 3a and the virtual transmission image 6a are significantly different, the known material parameter may be set again in correspondence with the difference in position.

### Aspects

It will be understood by those skilled in the art that the exemplary embodiments described above are specific examples of the following aspects.

### Item 1

An X-ray inspection method, comprising:

an X-ray transmission image acquisition step of performing X-ray imaging of an object to acquire a two-dimensional X-ray transmission image;

a model generation step of generating a model corresponding to the object including a defect as a three-dimensional virtual model, using a known structural parameter for the object;

a virtual transmission image generation step of generating a two-dimensional virtual transmission image from the three-dimensional virtual model; and

a parameter modification step of modifying a structural parameter of the three-dimensional virtual model so as to make the two-dimensional virtual transmission image closer to the two-dimensional X-ray transmission image, using a comparison result between the two-dimensional X-ray transmission image and the two-dimensional virtual transmission image.

The configuration of generating a model corresponding to the object including a defect as a three-dimensional virtual model using the known structural parameter for the object eliminates the need to generate a three-dimensional model from an X-ray transmission image. This eliminates the need to collect a large amount of X-ray transmission images of the object for generating the three-dimensional virtual model, and can suppress the time for volume calculation for generating the three-dimensional model. As a result, three-dimensional data of a defect in the object can be acquired in a short time.

### Item 2

The X-ray inspection method according to item 1, wherein the known structural parameter includes a known structural parameter of the object and a known structural parameter of the defect existing in the object.

In this case, since the degree of similarity between the virtual model and the object becomes high, the difference between the two-dimensional virtual transmission image generated using the three-dimensional virtual model and the two-dimensional X-ray transmission image obtained from the object becomes small. This can reduce the amount of modification of the structural parameters of the three-dimensional virtual model in the modification parameter step. As a result, three-dimensional data of a defect in the object can be acquired in a shorter time.

### Item 3

The X-ray inspection method according to item 1, wherein the parameter modification step modifies a structural parameter of a different portion between the two-dimensional X-ray transmission image and the two-dimensional virtual transmission image, without modifying a structural parameter of the entire three-dimensional virtual model.

In this case, since the structural parameter of the entire three-dimensional virtual model is not modified in the modification parameter step, the amount of modification of the structural parameters of the three-dimensional virtual model can be reduced. Further, since the structural parameter of the different portion between the two-dimensional X-ray transmission image and the two-dimensional virtual transmission image is modified, the three-dimensional virtual model can be appropriately modified.

### Item 4

The X-ray inspection method according to item 1, further comprising a defect identification step of, after the parameter modification step, identifying at least one of a position, a shape, and a size of the defect with respect to the object.

In this case, since at least one of the position, shape, or size of the defect with respect to the object is identified using the virtual model that has been modified to be similar to the object by modifying the structural parameters, the defect can be appropriately identified.

### Item 5

The X-ray inspection method according to item 4, wherein the defect identification step displays at least one of the position, the shape, and the size of the defect with respect to the object as list data.

In this case, since at least one of the position, shape, or size of the defect can be easily recognized visually as list data, the defect can be easily identified.

### Item 6

The X-ray inspection method according to item 4, further comprising a modified model generation step of generating the three-dimensional virtual model after modification as a three-dimensional modified virtual model, using the structural parameter modified by the parameter modification step,

wherein the defect identification step displays the defect with respect to the object on the three-dimensional modified virtual model so as to be distinguishable from the object.

In this case, since the defect is displayed distinguishably from the object on the virtual model that has been modified to be similar to the object by modifying the structural parameters, the defect can be identified more easily visually.

### Item 7

The X-ray inspection method according to item 1, wherein the virtual transmission image generation step generates the two-dimensional virtual transmission image from the three-dimensional virtual model by performing a simulation that reflects an imaging parameter used in the X-ray transmission image acquisition step.

In this case, since the two-dimensional virtual transmission image is generated by a simulation that reflects the imaging parameter used in the X-ray transmission image acquisition step, a virtual transmission image similar to the X-ray transmission image generated from the object can be obtained. This allows a more accurate comparison result between the X-ray transmission image and the two-dimensional virtual transmission image to be obtained. As a result, the structural parameters can be modified more accurately.

### Item 8

The X-ray inspection method according to item 1, further comprising a known structural parameter acquisition step of acquiring a known structural parameter of the defect as the known structural parameter, using a difference obtained by comparing the X-ray transmission image and a two-dimensional defect-free virtual transmission image that does not include the defect.

In this case, even if a known structural parameter of the defect is not prepared, a structural parameter regarding the defect can be acquired by comparing the X-ray transmission image and the two-dimensional defect-free virtual transmission image that does not include the defect. As a result, since the known structural parameter of the defect is always acquired before the generation of the virtual model, a virtual model reflecting the known structural parameter of the defect can be generated.

### Item 9

The X-ray inspection method according to item 1, wherein the model generation step generates the three-dimensional virtual model using a known material parameter including information regarding a material of the object, in addition to the known structural parameter.

In this case, since the known material parameter can be reflected in the generation of the three-dimensional virtual model, a more appropriate virtual transmission image can be generated even for an object in which different types of materials with different X-ray transmittances, such as resin and metal, are combined.

### Item 10

The X-ray inspection method according to item 9, wherein the virtual transmission image generation step generates the two-dimensional virtual transmission image based on a linear attenuation coefficient distribution representing a degree of X-ray attenuation that differs for each material, the distribution being generated from the three-dimensional virtual model generated using the known structural parameter and the known material parameter.

Here, for example, especially when an X-ray transmission image is generated from a material with low X-ray transmittance, such as metal, noise called an artifact may occur in the X-ray transmission image. In this case, if an X-ray transmission image with an artifact is compared with a virtual transmission image without an artifact, the information of the defect to be known cannot be distinguished from the artifact, and the structural parameters of the virtual model may not be appropriately modified. Therefore, with the above configuration, since the two-dimensional virtual transmission image is generated based on the linear attenuation coefficient distribution representing the degree of X-ray attenuation that differs for each material, a virtual transmission image that reproduces the artifact can be generated. Therefore, it becomes possible to compare an X-ray transmission image with an artifact and a virtual transmission image that reproduces the artifact. As a result, the difference between the X-ray transmission image and the virtual transmission image becomes clear, and the information of the defect of the object included in the X-ray transmission image can be acquired more appropriately.

### Item 11

The X-ray inspection method according to item 1, further comprising, before the parameter modification step, a defect information detection step of detecting information of the defect with respect to the object, based on a detection defect transmission image as a two-dimensional defect transmission image, the detection defect transmission image being generated using a trained model that takes the two-dimensional X-ray transmission image and the two-dimensional virtual transmission image as input data and outputs the two-dimensional defect transmission image as output data.

In this case, since a trained model that takes the two-dimensional X-ray transmission image and the two-dimensional virtual transmission image as input data and outputs a defect transmission image is used, for example, if the trained model is made to learn an X-ray transmission image including an artifact, it can appropriately output a defect transmission image even for an X-ray transmission image including an artifact. That is, by using a trained model, for example, the information of the defect of the object included in the X-ray transmission image can be acquired more appropriately than in the case of simply obtaining the difference value between the two-dimensional X-ray transmission image and the two-dimensional virtual transmission image.

### Item 12

The X-ray inspection method according to item 11, wherein the detection defect transmission image includes a third defect transmission image generated using a first defect transmission image directly generated using the trained model, and a second defect transmission image generated by forward-projecting a defect tomographic image that is generated by back-projecting the first defect transmission image, and

the defect information detection step detects the information of the defect with respect to the object based on the third defect transmission image.

Here, when the object has a complex structure, or when beam hardening occurs where the average energy of X-rays becomes high, the contrast of the X-ray transmission image input to the trained model becomes low, and it may be difficult to reflect a delicate defect in the first defect transmission image output by the trained model. Therefore, by further performing forward projection on the defect tomographic image obtained by back-projecting the first defect transmission image, a second defect transmission image can be generated that is corrected so that a delicate defect can be reflected in the first defect transmission image. On the other hand, the second defect transmission image may have image blur. Therefore, it is effective to generate a third defect transmission image that reflects a delicate defect with less blur by performing a synthesis that compensates for the drawbacks of both, based on the first defect transmission image and the second defect transmission image. Therefore, with the above configuration, since the information of the defect can be detected based on the third defect transmission image that reflects a delicate defect with less blur, the information of the defect of the object included in the X-ray transmission image can be acquired even more appropriately.

### Item 13

The X-ray inspection method according to item 12, wherein the trained model is generated by learning at least one or more of a training defect tomographic image generated by back-projecting a first training defect transmission image, a second training defect transmission image generated by forward-projecting the training defect tomographic image, and a third training defect transmission image generated using the first training defect transmission image and the second training defect transmission image, in addition to the first training defect transmission image acquired in advance as a teacher image for training to output the first defect transmission image.

In this case, since the trained model learns at least one or more of the training defect tomographic image, the second training defect transmission image, and the third training defect transmission image, in addition to the first training defect transmission image, it can output the first defect transmission image with higher accuracy compared to the case where the trained model learns only the first training defect transmission image.

### Item 14

The X-ray inspection method according to item 13, wherein the trained model is generated by learning with weighting applied to each of the first training defect transmission image, the training defect tomographic image, the second training defect transmission image, and the third training defect transmission image.

Here, when the weights of the training data that the trained model learns, namely, the first training defect transmission image, the training defect tomographic image, the second training defect transmission image, and the third training defect transmission image, are adjusted, the degree of influence of each training data on the output is adjusted. Therefore, with the above configuration, for example, appropriate learning can be performed on the trained model according to the degree of importance for the trained model to generate an optimal first defect transmission image.

### Item 15

An X-ray inspection apparatus, comprising:

an imaging unit for performing X-ray imaging of an object; and

a control unit for controlling the imaging unit,

wherein the control unit is configured to perform:

control to acquire a two-dimensional X-ray transmission image of the object;

control to generate a model corresponding to the object including a defect as a three-dimensional virtual model, using a known structural parameter for the object;

control to generate a two-dimensional virtual transmission image from the three-dimensional virtual model; and

control to modify a structural parameter of the three-dimensional virtual model so as to make the two-dimensional virtual transmission image closer to the two-dimensional X-ray transmission image, using a comparison result between the two-dimensional X-ray transmission image and the two-dimensional virtual transmission image.

In the present invention as well, a technical effect similar to that of item 1 can be obtained.

### REFERENCE SIGNS LIST

1 Object

2 Defect

3 X-ray projection data

3a X-ray transmission image (two-dimensional X-ray transmission image)

4 Virtual model (three-dimensional virtual model)

4a Virtual object model

4b Virtual defect model

5 Defect-free virtual model

6 Virtual X-ray projection data

6a Virtual transmission image

7 Modified virtual model

7a Modified virtual object

7b Modified virtual defect model

8 Modified virtual projection data

8a Modified virtual transmission image

9 Defect-free virtual projection data

9a Defect-free virtual transmission image

10 X-ray imaging unit (imaging unit)

11 X-ray irradiation unit

12 X-ray detection unit

20 Inspection unit

21 Control unit

21a X-ray image generation unit

21b Model generation unit

21c Virtual transmission image generation unit

21d Transmission image calculation unit

22a Object known structural parameter

22b Defect known structural parameter

22c Object known material parameter (known material parameter)

22d First trained model (trained model)

22e Second trained model (trained model)

30 Linear attenuation coefficient distribution

40 First training projection data

40a First training transmission image

41 Second training projection data

41a Second training transmission image

42 First training defect projection data

42a First training defect transmission image

43 Training defect tomographic data

43a Training defect portion

44 Second training defect projection data

44a Second training defect transmission image

45 Third training defect projection data

45a Third training defect transmission image

50 Detection defect projection data

50a Detection defect transmission image

51 Detection defect tomographic data

51a Defect portion

60 First detection defect projection data

60a First detection defect transmission image (detection defect transmission image, first defect transmission image)

61 First defect tomographic data

61a Defect portion (detection tomographic image)

62 Second detection defect projection data

62a Second detection defect transmission image (detection defect transmission image, second defect transmission image)

63 Third detection defect projection data

63a Third detection defect transmission image (detection defect transmission image, third defect transmission image)

64 Second defect tomographic data

64a Defect portion

100, 200, 300 Defect inspection apparatus (X-ray inspection apparatus)

1. An X-ray inspection method, comprising:
an X-ray transmission image acquisition step of performing X-ray imaging of an object to acquire a two-dimensional X-ray transmission image;
a model generation step of generating a model corresponding to the object including a defect as a three-dimensional virtual model, using a known structural parameter for the object;
a virtual transmission image generation step of generating a two-dimensional virtual transmission image from the three-dimensional virtual model; and
a parameter modification step of modifying a structural parameter of the three-dimensional virtual model so as to make the two-dimensional virtual transmission image closer to the two-dimensional X-ray transmission image, using a comparison result between the two-dimensional X-ray transmission image and the two-dimensional virtual transmission image.

2. The X-ray inspection method according to claim 1, wherein the known structural parameter includes a known structural parameter of the object and a known structural parameter of the defect existing in the object.

3. The X-ray inspection method according to claim 1, wherein the parameter modification step modifies a structural parameter of a different portion between the two-dimensional X-ray transmission image and the two-dimensional virtual transmission image, without modifying a structural parameter of the entire three-dimensional virtual model.

4. The X-ray inspection method according to claim 1, further comprising a defect identification step of, after the parameter modification step, identifying at least one of a position, a shape, and a size of the defect with respect to the object.

5. The X-ray inspection method according to claim 4, wherein the defect identification step displays at least one of the position, the shape, and the size of the defect with respect to the object as list data.

6. The X-ray inspection method according to claim 4, further comprising a modified model generation step of generating the three-dimensional virtual model after modification as a three-dimensional modified virtual model, using the structural parameter modified by the parameter modification step,
wherein the defect identification step displays the defect with respect to the object on the three-dimensional modified virtual model so as to be distinguishable from the object.

7. The X-ray inspection method according to claim 1, wherein the virtual transmission image generation step generates the two-dimensional virtual transmission image from the three-dimensional virtual model by performing a simulation that reflects an imaging parameter used in the X-ray transmission image acquisition step.

8. The X-ray inspection method according to claim 1, further comprising a known structural parameter acquisition step of acquiring a known structural parameter of the defect as the known structural parameter, using a difference obtained by comparing the X-ray transmission image and a two-dimensional defect-free virtual transmission image that does not include the defect.

9. The X-ray inspection method according to claim 1, wherein the model generation step generates the three-dimensional virtual model using a known material parameter including information regarding a material of the object, in addition to the known structural parameter.

10. The X-ray inspection method according to claim 9, wherein the virtual transmission image generation step generates the two-dimensional virtual transmission image based on a linear attenuation coefficient distribution representing a degree of X-ray attenuation that differs for each material, the distribution being generated from the three-dimensional virtual model generated using the known structural parameter and the known material parameter.

11. The X-ray inspection method according to claim 1, further comprising, before the parameter modification step, a defect information detection step of detecting information of the defect with respect to the object, based on a detection defect transmission image as a two-dimensional defect transmission image, the detection defect transmission image being generated using a trained model that takes the two-dimensional X-ray transmission image and the two-dimensional virtual transmission image as input data and outputs the two-dimensional defect transmission image as output data.

12. The X-ray inspection method according to claim 11, wherein the detection defect transmission image includes a third defect transmission image generated using a first defect transmission image directly generated using the trained model, and a second defect transmission image generated by forward-projecting a defect tomographic image that is generated by back-projecting the first defect transmission image, and
the defect information detection step detects the information of the defect with respect to the object based on the third defect transmission image.

13. The X-ray inspection method according to claim 12, wherein the trained model is generated by learning at least one or more of a training defect tomographic image generated by back-projecting a first training defect transmission image, a second training defect transmission image generated by forward-projecting the training defect tomographic image, and a third training defect transmission image generated using the first training defect transmission image and the second training defect transmission image, in addition to the first training defect transmission image acquired in advance as a teacher image for training to output the first defect transmission image.

14. The X-ray inspection method according to claim 13, wherein the trained model is generated by learning with weighting applied to each of the first training defect transmission image, the training defect tomographic image, the second training defect transmission image, and the third training defect transmission image.

15. An X-ray inspection apparatus, comprising:
an imaging unit for performing X-ray imaging of an object; and
a control unit for controlling the imaging unit,
wherein the control unit is configured to perform:
control to acquire a two-dimensional X-ray transmission image of the object;
control to generate a model corresponding to the object including a defect as a three-dimensional virtual model, using a known structural parameter for the object;
control to generate a two-dimensional virtual transmission image from the three-dimensional virtual model; and
control to modify a structural parameter of the three-dimensional virtual model so as to make the two-dimensional virtual transmission image closer to the two-dimensional X-ray transmission image, using a comparison result between the two-dimensional X-ray transmission image and the two-dimensional virtual transmission image.
